(19) United States
(12) Patent Application Publication
(10) Pub. No.: US 2024/0178628 A1
(43) Pub. Date: May 30, 2024

(54) PHOTOACOUSTIC SYSTEM AND ASSOCIATED METHOD

(71) Applicant: COMMISSARIAT À L’ENERGIE ATOMIQUE ET AUX ENERGIES ALTERNATIVES, PARIS (FR)

(72) Inventors: Badhise BEN BAKIR, GRENOBLE CEDEX 09 (FR); Olivier LARTIGUE, GRENOBLE CEDEX 09 (FR); Christophe CONSTANCIAS, GRENOBLE CEDEX 09 (FR)

(21) Appl. No.: 18/521,440

(22) Filed: Nov. 28, 2023

(30) Foreign Application Priority Data
Nov. 29, 2022 (FR) 2212507

(51) Int. Cl. H01S 3/063; G01N 29/24; H01S 3/08

(52) U.S. Cl. CPC H01S 3/0635; G01N 29/2418; H01S 3/08009

(57) ABSTRACT

A photoacoustic system includes a semiconductor substrate including a hollow volume and a window extending in vertical alignment with a part of the hollow volume, and a surface emitting device including a waveguide and a diffraction grating, the waveguide having an upper face and a lower face, the lower face being disposed on the window, the diffraction grating being disposed on the upper face or on the lower face.

### CROSS-REFERENCE TO RELATED APPLICATIONS

This application claims priority to French Patent Application No. 2212507, filed Nov. 29, 2022, the entire content of which is incorporated herein by reference in its entirety.

### FIELD

The technical field of the invention is that of photoacoustic systems, for example, implemented in the detection of chemical compounds in a gas or in a vascularised skin sample.

### BACKGROUND

Photoacoustic detection systems can be used to detect and quantify target species present in a continuous medium such as a gas or a liquid. Photoacoustic detection systems are based on the emission of an acoustic wave in the continuous medium in response to the selective excitation of target atoms or molecules in this continuous medium by means of a light beam. The acoustic wave, sensed by a microphone, is proportional to the density of target atoms or molecules in the continuous medium.

The principle of photoacoustics has been known for several decades, but the development of a photoacoustic detector system that can be miniaturised and accurate still raises a number of technical problems.

With this in mind, document [“Downsizing and Silicon Integration of Photoacoustic Gas Cells” Gliére & al, International Journal of Thermophysics (2020) 41:16] discloses a detection system comprising a volume for accommodating the continuous medium. However, the disclosed system is remarkable in that the volume is restricted. Indeed, the photoacoustic signal is inversely proportional to the volume of the continuous medium in which the acoustic wave propagates. A direct way of improving the resolution of a detection system is therefore to reduce the volume involved, ideally to the limit of a few cubic micrometres for a measurement at atmospheric pressure (otherwise the volume is too small for the probability of a photon interacting with a gas molecule to be sufficient). The system disclosed takes advantage of Si device manufacturing methods, which allow very small hollow volumes to be formed within a silicon substrate itself. In particular, it is disclosed that an array of trenches is etched into the surface of two separate substrates. The two substrates are then bonded together so that the trench patterns face each other. The two separate substrates thus form a thick substrate and the two trench arrays form a hollow volume within the volume of the thick substrate, beneath the surfaces of said thick substrate. The disclosed hollow volume comprises a main, rectilinear cavity and a transparent window disposed on an edge of the thick substrate. A light beam aligned with the window (referred to as abutment) can then enter the main cavity and interact with the medium present in the cavity. Thus, a laser beam correctly aligned with the first cavity can interact with the continuous medium present in the main cavity and induce a photoacoustic response in the medium.

However, this geometry poses new problems. Indeed, the response of the detection system is very sensitive to the misalignment or angular divergence of the laser beam with said main cavity. In a laboratory environment, it is possible to implement an active beam alignment device and a high-performance collimation system. However, its implementation is complex and does not meet the needs of miniaturisation or integration in a lab on chip. Integrating a non-collimated laser source (such as a laser diode) in proximity to the optical window makes it possible to integrate the system into a lab on chip. However, it requires a high-amplitude laser source to compensate for the weak coupling with the cavity and/or its high angular divergence.

In addition, poor control of the alignment of the beam with the cavity or poor control of the distance of the source from the optical window leads to a high dispersion of resolution between several detection systems of the same type.

There is therefore a need to provide a photoacoustic system that is efficient, reproducible and can be integrated into a lab on chip.

### SUMMARY

To this end, an aspect of the invention relates to a photoacoustic system comprising: a semiconductor substrate, the semiconductor substrate comprising:
a face referred to as an “upper face”; and
an inner wall delimiting a hollow volume, the hollow volume extending into the semiconductor substrate at a distance from the upper face of said semiconductor substrate.

The photoacoustic system is remarkable in that:
the semiconductor substrate comprises at least one portion, referred to as a “window”, transparent to an electromagnetic field, extending in vertical alignment with at least one part of the hollow volume and from the upper face of the semiconductor substrate to the hollow volume; and in that
the photoacoustic system comprises at least one surface emitting device comprising an emitting face, said emitting face extending over said at least one window, said at least one device comprising:
   a waveguide comprising a first face and a second face, opposite to the first face, the waveguide comprising an active region configured to emit the electromagnetic field; and
   a diffraction grating having, along a first direction parallel to the emitting face, a diffraction order greater than or equal to two,
   said diffraction grating extending over the first face of the waveguide, the emitting face being coincident with the second face of the waveguide; or said diffraction grating extending over the second face of the waveguide, the emitting face being coincident with the diffraction grating.

By transparent to the electromagnetic field, it is meant that the window has a transmission coefficient greater than 50%, in other words, at least 50% of the power carried by the electromagnetic field is transmitted through the window.

The fact that the diffraction grating has a diffraction order greater than or equal to two means that the electromagnetic field generated by the active region can be extracted. In particular, the diffraction grating allows a component of the field to propagate out of the plane. A substantial part of the power carried by the out-of-plane component (which we will call electromagnetic radiation) is thereby emitted by the second face of the waveguide.

By virtue of the window in the semiconductor substrate and the arrangement of the surface emitting device, the electromagnetic radiation from the surface emitting device is directly injected into the hollow volume. It can therefore be used to carry out a photoacoustic measurement. A surface emitting device emits electromagnetic radiation that is homogeneous in the near field and has low angular dispersion. Therefore, a continuous medium in the hollow volume in vertical alignment with the surface emitting device (and more particularly in vertical alignment with the window) can be effectively excited by the radiation from the surface emitting device. In addition, the small thickness of the window also reduces absorption of the radiation. Finally, the surface emitting device can be positioned as close as possible to the window (or even on the window) and therefore as close as possible to the hollow volume, so as to effectively illuminate a medium located in the hollow volume. The photoacoustic system according to the invention is therefore effective.

The fact that the surface emitting device extends over the upper face of the substrate and not in proximity to an edge of the substrate also simplifies its integration into the photoacoustic system. It simply needs to be deposited (or manufactured) onto the window. In addition, there are few sources of uncertainty relating to alignment. Since the surface emitting device is deposited onto the upper face (or on an optical shoe which is itself placed on the upper face), the uncertainty about its distance from or tilt to the upper face is low or even negligible. Furthermore, rotation of the device along an axis perpendicular to the window does not necessarily have any effect. The alignment restriction is therefore relaxed compared to a system according to prior art. In addition, the window can be enlarged as much as necessary to absorb an alignment error of the device in relation thereto. The measurement or detection results that can be obtained with several photoacoustic systems according to the invention are therefore reproducible.

The surface emitting device can have reduced dimensions, making it a good candidate for integration into a lab on chip. In addition, the dimensions, especially the lateral dimensions, of the surface emitting device can be reduced as much as necessary, to further reduce its size and the size of the photoacoustic system. It is remembered that measurement accuracy increases as the excited volume is reduced. The photoacoustic system according to the invention can therefore be easily integrated, for example into a lab on chip.

Beneficially, the diffraction grating of said at least one device extends over the first face of the waveguide of said at least one device and said diffraction grating is reflective.

Beneficially, the diffraction grating of said at least one device comprises a periodic structure and a metal layer, the periodic structure extending over the first face of the waveguide and the metal layer extending over the periodic structure.

Alternatively, the diffraction grating of said at least one device extends over the second face of the waveguide of said at least one device and said diffraction grating is non-reflective.

Beneficially, the periodic structure of the diffraction grating of said at least one device comprises alternating first portions and second portions, the first portions consisting of a first semiconductor material having a first optical index and the second portions consisting of a metal or a second material, such as another semiconductor material or a gas, having a second optical index different from the first optical index.

Beneficially, the diffraction grating of said at least one device extends in vertical alignment with the active region of the waveguide of said at least one device, the active region having a length, measured along the first direction, and the diffraction grating of said at least one device having a length, also measured along the first direction, the length of said diffraction grating being substantially equal to the length of said active region, said grating having, along the first direction, a single diffraction order.

In an embodiment, the diffraction grating of said at least one device has, along the first direction, a diffraction order greater than or equal to three.

Beneficially, the active region of said at least one device has a width, measured in a second direction, parallel to the emitting face of said at least one device and perpendicular to the first direction, and the diffraction grating of said at least one device has a width, measured in the second direction, the width of said diffraction grating being substantially equal to the width of said active region, said diffraction grating having, along the second direction, another diffraction order, which is unique and greater than or equal to two.

Beneficially, the waveguide of said at least one device is delimited by a first flank and a second flank, the second flank being opposite to the first flank, the first and second flanks being substantially perpendicular to the second face, said device also comprising a first conductive layer and a second conductive layer, the first conductive layer extending over the first flank and the second conductive layer extending over the second flank.

Beneficially, said at least one surface emitting device is bonded to the window and, in an embodiment, by molecular bonding or by means of a polymerisable adhesive.

Beneficially, said at least one surface emitting device is configured to emit infrared electromagnetic radiation through its emitting face at an angle, measured relative to the normal of said emitting face, of between 0° and 60°.

Beneficially, the semiconductor substrate comprises a plurality of windows and the photoacoustic system comprises a plurality of surface emitting devices, each surface emitting device of the plurality of surface emitting devices being disposed on one window of the plurality of windows.

Beneficially, the electromagnetic radiation comprises a wavelength in the range [0.8 μm; 20 μm] and, in an embodiment, in the range [4 μm; 12 μm].

Beneficially, the photoacoustic system comprises a heat regulator configured to regulate temperature of said at least one surface emitting device.

In an embodiment, the heat regulator is configured to regulate temperature of said at least one surface emitting device when said at least one surface emitting device is operating in steady state.

In an embodiment, the heat regulator is configured to regulate temperature of said at least one surface emitting device to within 0.1° C.

Alternatively, the heat regulator is configured to regulate time variation of the temperature of the at least one surface emitting device to within 0.1° C./s.

The invention also relates to a method for manufacturing a photoacoustic system comprising, from a semiconductor substrate comprising a face referred to as an “upper face”:
forming an inner wall delimiting a hollow volume, the hollow volume extending into the semiconductor substrate at a distance from the upper face of said semiconductor substrate so that the semiconductor substrate comprises at least one portion, referred to as a “window”, which is transparent to an electromagnetic field, extending in vertical alignment with at least one part of the hollow volume and from the upper face of the semiconductor substrate to the hollow volume;
manufacturing at least one surface emitting device extending over the window, said at least one device comprising:
   a waveguide comprising a first face and a second face, opposite to the first face, the second face resting on said at least one window, the waveguide comprising an active region parallel to the second face configured to emit the electromagnetic field; and
   a diffraction grating having a diffraction order greater than or equal to two and extending over the first face of the waveguide or over the second face of the waveguide.

Beneficially, manufacturing said at least one surface emitting device comprises:
forming the waveguide of said at least one device on said at least one window of the semiconductor substrate; and
forming the diffraction grating of said at least one device on the first face of said waveguide.

Alternatively, manufacturing said at least one surface emitting device comprises:
forming the diffraction grating of said at least one device on said at least one window of the semiconductor substrate; and
forming the waveguide of said at least one device on said diffraction grating.

The invention and its different applications will be better understood upon reading the following description and upon examining the accompanying figures.

### BRIEF DESCRIPTION OF THE FIGURES

The figures are set forth by way of indicating and in no way limiting purposes of the invention. Unless otherwise specified, a same element appearing in different figures has a single reference.

[FIG. 1a], [FIG. 1b], [FIG. 3a], [FIG. 3b], [FIG. 4], [FIG. 5] and [FIG. 6] schematically show first, second, third, fourth and fifth embodiments of a photoacoustic system according to the invention.

FIG. 2 schematically shows one embodiment of a surface emitting device that can be implemented in the photoacoustic system according to the invention.

FIG. 7a and [FIG. 7b] schematically show two implementation modes of a method for manufacturing a photoacoustic system according to the invention.

### DETAILED DESCRIPTION

FIG. 1a and [FIG. 1b] schematically show an embodiment of a photoacoustic system 1 according to the invention. In this embodiment, the system 1 is adapted to perform measurement of a concentration of a targeted species in a gas. The system 1 is based on the measurement of a sound wave resulting from photoacoustic emission by the targeted species in the gas.

System 1 especially comprises a surface emitting device 3, two sound sensors 4 (in other words microphones) and a Helmholtz resonator 21 into which the gas containing the targeted species can be introduced. The surface emitting device 3 is coupled to the Helmholtz resonator so as to inject electromagnetic radiation that can excite the target species in the gas. Sound sensors 4 are coupled to the resonator 21 in order to measure amplitude of the sound waves propagating in the resonator 21 and resulting from the photoacoustic emission by the targeted species.

The system 1 illustrated in [FIG. 1a] and [FIG. 1b] is partially truncated, according to two different configurations, to show elements of the system 1.

System 1 as illustrated comprises a semiconductor substrate 2 comprising the resonator 21. The substrate 2 extends in a plane {X; Y} formed by a first direction X and a second direction Y, orthogonal to the first direction X. The substrate 2 comprises two large faces 2a, 2b, opposite to each other. That is to say, a face 2a referred to as the “upper face”, oriented along a third direction Z, and a face 2b referred to as the “lower face”, oriented along the third direction −Z and opposite to the upper face 2a. The two large faces 2a, 2b are delimited by a flank 2c (also referred to as an “edge”), forming the perimeter of the substrate 2.

The substrate 2 may have a thickness W₂, measured along the direction Z, of between [0.5 mm and 3 mm]. The substrate 2 may have a length L₂ and a width I₂, respectively measured along the first and second directions X and Y, in the range [5 mm; 20 mm].

The resonator 21 comprises two hollow volumes 21a, 21b which will also be referred to as “main cavities”. The main cavities 21a, 21b extend parallel to each other along X. They extend into the volume of the substrate 2, below the upper face 2a of the substrate 2. In other words, they extend at a distance from the upper face 2a. Each of the main cavities 21a, 21b is delimited by an inner wall in the substrate 2. The resonator 12 also comprises channels 211 connecting the main cavities 21a, 21b. The channels 211 illustrated each have an opening 212, formed in the upper face 2a of the substrate 2. These openings 212 may serve to introduce the gas and target species into the resonator 21.

The semiconductor substrate 2 may be formed from two thin semiconductor substrates 2′, 2″ assembled together. For example, a line 20 illustrates the interface between the two assembled thin substrates 2′, 2″. To form the thick substrate 2, each of the thin substrates 2′, 2″ is etched to form trenches that will make up the resonator 21. The assembly of the two substrates 2′, 2″ against each other, so that their respective trenches face each other, forms the substrate 2 and the resonator 21.

The substrate 2 is in an embodiment made of Si.

The substrate 2 comprises a portion 22 referred to as a “window”. By window, it is meant that it is adapted to transmit electromagnetic radiation into the resonator 21 and in particular into one of the main cavities 21a, 21b. The window 22 extends in vertical alignment with at least one part of one of the main cavities 21a, 21b. By extending in vertical alignment with the surface, it is meant that the window is aligned with a portion of a cavity 21a, 21b along the direction Z (perpendicular to the upper face 2a). The window 22 extends into the substrate 2 and connects the upper surface 2a of the substrate 2 to one of the cavities 21a, 21b. The window 22 is therefore not an opening provided in the substrate 2 so as to expose a cavity 21a, 22b. The window 22 may be made of the same material as the substrate 2, for example Si. The transmission coefficient of the window 22 may vary according to the thickness W₂₂ of the window 22, measured along the direction Z. A window 22 made of Si can be considered transparent to infrared radiation in the range [0.8 μm; 20 μm] when its thickness W₂₂ is less than or equal to 100 μm. A smaller window thickness W₂₂, for example less than or equal to 50 μm, may be favoured to further improve transmission of infrared radiation. The window can also be made from another material, especially if it offers better transmission of electromagnetic radiation at some wavelengths. For example, it could be a silicon nitride or silicon carbide portion.

In the embodiment of [FIG. 1a] and [FIG. 1b], the window 22 is associated with a cavity 21a of the resonator 21. In one development, the substrate 2 may comprise a plurality of windows associated with a cavity. For example, the windows extend from the upper face 2a of the substrate 2 to the same cavity 21a, but to different portions of said cavity 21a. Thus, the system 1 may comprise a plurality of surface emitting devices 3, each disposed on one of the windows. In this way, the plurality of devices is coupled to the same cavity. This can be useful for exposing the same cavity to radiation of different wavelengths (for example to detect different species).

The surface emitting device 3 is used to inject electromagnetic radiation into the resonator 21 and in particular into the main cavity 21a, 21b with which the window 22 is associated.

By surface emitting device, it is meant an electro-optical device configured to emit electromagnetic radiation from one of its faces, which is generally referred to as the “emitting face”. It is differentiated from an edge-emitting device in which electromagnetic radiation is emitted at an edge or a flank of said device.

The interest of a surface emitting device 3 is double. Firstly, it is possible to emit radiation along an out-of-plane direction. Namely, in the case of [FIG. 1a] and [FIG. 1b], out of the plane {X; Y}. For example, along the direction Z. Device 3 also allows radiation to be emitted from a surface (the so-referred to as “emitting” face) which has an area larger than an edge. The emitting face generally has a large area and makes it possible to obtain spatially homogeneous electromagnetic radiation, especially in the near field. It is therefore beneficial to resort to this type of device to inject electromagnetic radiation into the resonator 21 and effectively excite the targeted species in the gas.

Device 3 is configured to emit via a face 3b, which will be referred to as the “emitting face”. The electromagnetic radiation from the emitting face 3b is substantially perpendicular to the emitting face 3b. By substantially perpendicular, it is meant that the radiation has an angle greater than or equal to 30° with the emitting face 3b (that is between 30° and 90°).

In order to inject the electromagnetic radiation into the resonator 21 and in particular into the cavity 21a, the surface emitting device 3 is disposed on the window 22. The emitting face 3b of the surface emitting device 3 is disposed in direct contact with the window 22a. In this way, the electromagnetic radiation emitted by the device 3 is directly transmitted to the cavity 21a. The emitted radiation can then excite the targeted species present in the resonator 21.

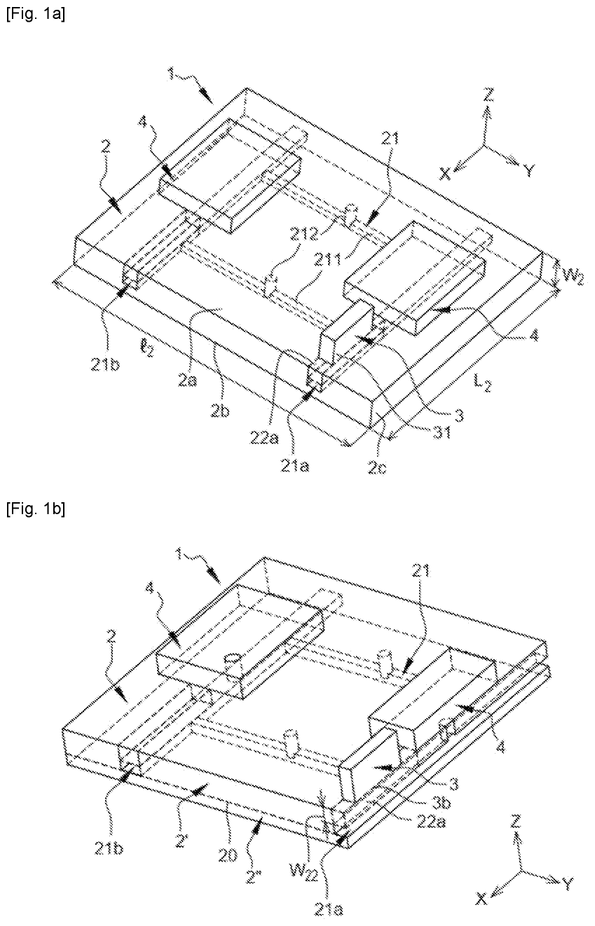

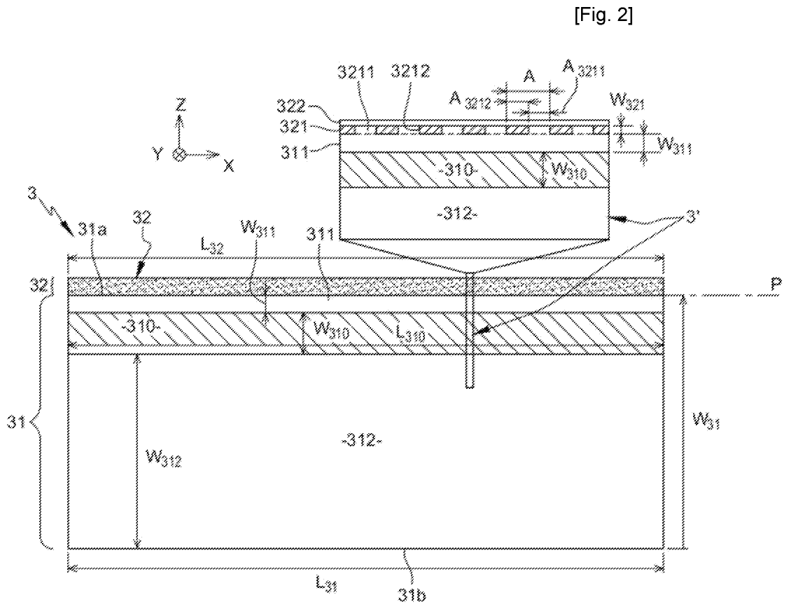

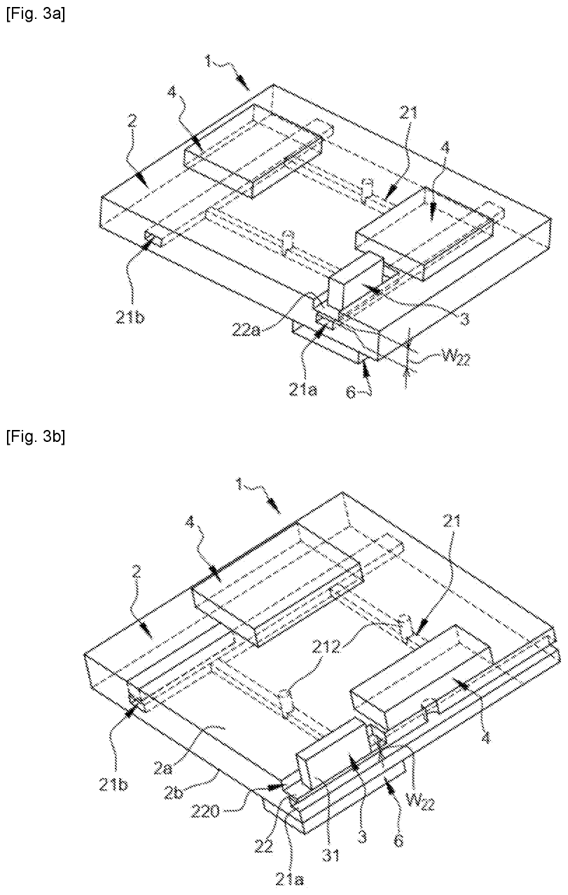

FIG. 2 shows, along a cross-section view, one embodiment of a surface emitting device 3 that can be used in the photoacoustic system 1. The device 3 is represented along a cross-section in the plane {X; Z}. [FIG. 2] also shows a magnification of a portion 3′ of said device 3, in the same plane.

Device 3 comprises: a waveguide 31 and a diffraction grating 32.

The waveguide 31 extends in a plane P which is, for example, parallel to the upper surface 2a of the system 1 (that is the plane {X; Y}). The waveguide 31 comprises a first face 31a and a second face 31b, opposite to the first face 31b. The first and second faces 31a, 31b extend parallel to the plane P. The first face 31a is oriented, for example, along the third direction Z, perpendicular to the plane P, and the second face 31b is oriented according to the same direction but in an opposite direction.

The waveguide 31 also comprises an active region 310. The active region 310 is a portion of the waveguide 31 configured to emit an electromagnetic field (also referred to as “electromagnetic radiation” or simply “field” or “radiation”). The active region 310 is, for example, configured so that the emission is spontaneous and/or stimulated. In the latter case, the active region could also be referred to as an “amplifying medium” because it can enable the device 3 to operate in laser mode. The active region 310 is for example a stack of sublayers, such as [InGaAs/AlInAs]×N, where N is the number of pairs of InGaAS/AlInAs sublayers, for example equal to one hundred. In this way, the active region 310 is configured to perform spontaneous and stimulated emission.

The active region may have a thickness W₃₁₀, measured perpendicular to the plane P, of between 1 μm and 5 μm and, in an embodiment, between 1.5 μm and 2.5 μm.

The active region 310 is in an embodiment framed by two semiconductor layers 311, 312 extending parallel to the plane P. A first semiconductor layer 311, which may be referred to as a “top cladding”, extends over the active region 310 and, in an embodiment, directly against the active region 310. In this embodiment, the face of the top cladding 311 that is opposite to the active region 310 is beneficially the first face 31a. A second semiconductor layer 312, which may be referred to as “bottom cladding”, also extends over the active region 310 and, in an embodiment, against the active region 310. The face of the bottom cladding 312 opposite to the active region 310 is then beneficially the second face 31b.

The top and bottom claddings 311, 312 can be used to guide the field in the waveguide 31. For this, they beneficially have optical indices (also referred to as refractive indices) that are strictly lower than the average optical index of the active region 310.

The top cladding 311 has a thickness, measured perpendicular to the plane P, of between 1 μm and 2 μm. The bottom cladding 312 has a thickness, measured perpendicularly to the plane P, which may be between 2 μm and 100 μm and, in an embodiment, between 2 μm and 40 μm.

The bottom cladding 312 is, for example, a III-V type semiconductor heterostructure, that is materials classified in groups IIIB and VB of the periodic table of elements (which, according to another convention, corresponds to columns 13 and 15 of the periodic table of elements). Said coating 312 is for example formed from InP.

The bottom cladding 312 may also be doped, for example n-type, that is with impurities acting as electron donors. The bottom cladding 312 is for example doped from S.

The top coating 311 may be, in the same way as the bottom coating 312, a type III-V semiconductor heterostructure, such as InP. In the same way, the top coating 311 may be doped, for example n-type.

In the embodiment of [FIG. 2], the waveguide 31 is therefore a stack of layers 310, 311, 312 extending parallel to the plane P. It may have the shape of a rectangular parallelepiped delimited by the flanks. For example, it has a length L₃₁, a width and a thickness W₃₁. The length of the waveguide 31 is measured, for example, along the first direction X. The width of the waveguide 31 is for example measured along the second direction Y, perpendicular to the first direction X. The thickness W₃₁ of the waveguide 31 is for example measured along the third direction Z, perpendicular to the two aforementioned directions X, Y.

The length L₃₁ of the waveguide 31 may be between 1000 μm and 5000 μm. According to one embodiment, the length L₃₁ and the width of the waveguide 31 may be equal, for example to within 10%. Thus, seen from above, the first face 31a may have a square shape. Alternatively, the length L₃₁ of the waveguide 31 may be greater than the width of the waveguide 31 and, for example, greater than twice the width of the waveguide 31, or even greater than one hundred times the width of the waveguide. This is referred to as a “ridge” type waveguide. For example, the width of waveguide 31 (not represented in the figure) can be between 10 μm and 50 μm.

The active region 310 has a length L₃₁₀, measured along the first direction X, substantially equal to the length L₃₁ of the waveguide 31. Similarly, the active region 310 has a width, measured along the second direction Y, substantially equal to the width of the waveguide 31. By substantially equal, it is meant equal to within 20%, or even within 10%. Flanks perpendicular to the plane P for example delimit the waveguide 31 and the active region 310.

In the embodiment of [FIG. 2], the diffraction grating 32 extends over the first face 31a of the waveguide 31 and in particular over the top cladding 311. The emitting face 3b of the device 3 is thereby coincident with the second face 31b of the waveguide. By is coincident, it is meant that the faces are coplanar.

The diffraction grating is beneficially disposed in vertical alignment with the active region 310 of the waveguide 31 and, in an embodiment, centred with respect to the latter.

The diffraction grating 32 may have a length L₃₂ and a width. The length L₃₂ of the diffraction grating 32 is measured, for example, along the first direction X. The width of the diffraction grating 32 is, for example, measured along the second direction Y, perpendicular to the first direction X. The length L₃₂ and the width of the diffraction grating 32 are beneficially chosen so that the diffraction grating 32 completely covers the active region 310. In other words, the lengths and widths of the diffraction grating 32 are, respectively, substantially equal to the lengths and widths of the active region 310. In this way, the diffraction grating 32 can be homogeneously coupled to the field emitted by the active region 310. It makes it possible, for example, to provide homogeneously distributed feedback over the entire length L₃₁₀ of the active region 310.

The device 3 is remarkable on the one hand in that the second face 31b of the waveguide is transparent to the field that may be emitted by the active region 310. By transparent, it is meant that the face 31b has a spectral transmission window and that this spectral transmission window corresponds to at least one part of the spectrum of the field that can be emitted by the active region 310. The second face 31b of the waveguide 31 also constitutes the emitting face 3b of the device 3.

The device 3 is also remarkable in that the diffraction grating 32 is reflective and in that it has a diffraction order, along the first direction X, greater than or equal to two. By reflective, it is meant that at least 50% of the field is reflected by the diffraction grating 32. The diffraction order greater than or equal to two along the direction X implies that the field generated by the active region propagating along the first direction X couples with the diffraction grating 32 and induces a component of the field that propagates out of the P plane, that is along +Z and/or −Z. Since the diffraction grating 32 reflects the field component propagating along +Z, said field component is therefore oriented towards the second face 31b. The device 3 can therefore transmit via the second face 31b. The second face 31b of the waveguide 31 therefore is coincident with the emitting face 3b of the device 3.

Beneficially, the diffraction grating 32 comprises a periodic structure 321. The periodic structure 321 is, for example, a layer extending over the first face 31a of the waveguide 31. Coupled with the field emitted by the active region 310, it induces the diffraction effects. The rate of coupling between the field and the diffraction grating 32 is beneficially between 10 cm⁻¹ and 100 cm⁻¹.

The periodic structure 321 comprises, for example, first portions 3211 and second portions 3212. These first and second portions 3211, 3212 are arranged periodically and form one alternation along the first direction X and along the second direction Y if necessary.

For example, the first and second portions 3211, 3212 may be lines, oriented along the second direction Y. Said lines are arranged side by side along the first direction X so as to form an alternation along the first direction X. Stated differently, they form two interlocking combs. [FIG. 2] illustrates this example.

According to another example, the first portions 3211 are studs arranged in a rectangular mesh. For example, the second portions 3212 are cores surrounding each stud 3211 and filling the space between the studs 3211. According to one alternative to this example, the studs 3211 may have an elliptical shape, having a major side along the first direction X and a minor side along the second direction Y or vice versa.

The first portions 3211 consist of a first semiconductor material having a first optical index. The first semiconductor material is, for example, a III-V type semiconductor material, such as InP. It may also be the same material as the top coating 311. The second portions 3212 consist of a second material or a metal. The second material may be another semiconductor material or a gas, such as air. In this case it has a second optical index different from the first optical index.

The diffraction grating 32 beneficially has a single diffraction order along the first direction X. This means that the period A (or “pitch”) with which the first portions 3211 are arranged is constant over the entire length L₃₂ of the grating 12. Beneficially, the first portions 3211 thereby all have the same width A₃₂₁₁, measured along the first direction X. The second portions 3212, separating the first portions 3211, may also have the same width A₃₂₁₂, also measured along the first direction X. The period A of arrangement of the first portions 3211, which corresponds to the period of the diffraction grating 32 along the first direction X, is therefore equal to A₃₂₁₁+A₃₂₁₂. A single diffraction order means that the period A is constant, to within +/−10%, over the entire length L₃₂ of the diffraction grating.

The active region 310 is, in an embodiment, configured to emit in the infrared range, that is in a range [0.8 μm; 20 μm] or in an embodiment [4 μm; 12 μm]. Such wavelengths imply a period A of the grating 12 in the order of one micrometre at least. A diffraction grating 32 applicable to the infrared spectrum is also simpler to produce than a grating with a much smaller period (for example in the blue or ultraviolet spectrum). Furthermore, this type of grating lends itself beneficially to photoacoustic measurement or detection. In addition, a large family of semiconductor materials is transparent to infrared radiation.

The diffraction grating 32 also includes a metal layer 322 which extends over the periodic structure 321 and, in an embodiment, over the entire periodic structure 321. It is made of Ti or Au, for example. The reflective effect of the diffraction grating 32 can moreover be provided by the metal layer 322 extending over the periodic structure 321. The metal layer can prevent transmission of the field through the diffraction grating 32. The metal layer 12 extends especially over each first portion 3211 of the periodic structure 321. In this way it prevents transmission of the field through the first portions 3211.

The embodiment of [FIG. 2] illustrates a continuous metal layer 322 extending along the first direction X. Alternatively, the metal layer 322 may be discontinuous and comprise a plurality of portions. Each portion therefore beneficially extends over each first portion 3211 of the periodic structure 3211. If, for example, the first portions 3211 of the structure of the periodic structure 321 are aligned along the second direction Y, then the metal layer 322 will comprise a plurality of portions also extending along the second direction Y, a portion of the metal layer extending over an upper surface of a first portion 3211.

The metal layer 322 may also extend beyond the periodic structure 321 as it may also be used as a contact electrode of the device 3. It may enable an electric field to be uniformly applied to the active region 310 to inject carriers into the active region 310. The carriers can de-excite by emitting photons into the active region 310.

The metal layer 322 also improves containment of the field in the waveguide 31 by virtue of the plasmonic interaction of the field with the metal.

According to one alternative, the diffraction grating 32 can be configured so that, along the second direction Y, perpendicular to the first direction X, it also has an order greater than or equal to two. Thus the field propagating along the second direction Y also couples to the diffraction grating and induces a component of the field which also propagates out of the plane P, that is along +Z and/or −Z. This alternative can be obtained when the first portions 3211 of the periodic structure 321 are studs arranged according to a rectangular meshing. This alternative is beneficial when the width and length of the active region (and therefore of the diffraction grating) are substantially equal, for example to within 20%. On the other hand, if the length of the active region 310 is much greater than its width, for example 20 times greater than its width (“ridge” type guide), it is desirable for the diffraction grating 32 to have an order only along the first direction X and no order along the second direction Y. In other words, the first portions 3211 of the periodic structure 321 can be lines aligned along the second direction Y and distributed along the first direction X.

Where appropriate, the diffraction grating 32 may also have a single diffraction order along the second direction Y. The arrangement periods of the first and second portions along the first and second directions X and Y are thereby constant in both directions. However, they may be different, so that the order along the first direction X is different from the order along the second direction Y.

Lateral containment of the field can also be provided by conductive claddings extending over the sides of the waveguide 31. The waveguide 31 is, for example, delimited by a first flank and a second flank, opposite to each other. The first and second flanks are, for example, substantially perpendicular to the second direction Y. These are referred to as “lateral flanks” or “lateral facets”. The device 3 comprises first and second conductive layers which extend over the first and second flanks respectively. The conductive layers are, for example, metal layers of Ti or Au, extending perpendicular to the plane P. They form a cavity along the second direction Y of propagation and enable the field to be contained along the second direction Y.

In order to avoid short-circuit within the waveguide (for example a short-circuit of the upper cladding 311 with the lower cladding 312), the device 3 beneficially comprises electrically insulating spacers. These are dielectric layers, for example. Each spacer is disposed, for example, on the lateral flanks, between the conductive layers and the lateral flanks.

The device 3 can also include third and fourth conductive layers to help contain the field along the first direction. They extend, for example, over a third and fourth flank respectively, delimiting the waveguide 31 along the first direction X. The third and fourth flanks may be referred to as the “front facet” and the “rear facet”. The third and fourth flanks are, for example, perpendicular to the first direction X. The spacers are then beneficially arranged on the third and fourth flanks, between the third and fourth conductive layers and the third and fourth flanks so as to avoid any short-circuit.

In one alternative embodiment of the device 3, the diffraction grating 32 does not extend over the first face 31a of waveguide 31. Instead, it extends over the second face 31b of the waveguide 31. Herein, this is the face of waveguide 31 that faces the window 22a of the photoacoustic system 1. In other words, the diffraction grating 32 is coincident with the emitting face 3b of the device 3. The diffraction grating 32 is, for example, located between the device 3 and the window 22a. In order to allow the field to propagate towards the window 22a, the diffraction grating 32 is non-reflective. In other words, it transmits part of the power carried by the electromagnetic field.

The diffraction grating 32 may comprise a periodic structure 321 as previously described. However, this periodic structure extends over the second face 31b of the waveguide 31, for example over the lower cladding 312. The device 3 may also comprise a metal layer. However, the metal layer does not extend over the periodic structure 321, at the risk of blocking the transmission of the field. The metal layer may, however, extend over the first face 31a of the waveguide 31. In this way, it reflects the field propagating towards the first face 31a and makes it possible to increase the power passing through the periodic structure 321 on the second face 31b.

FIG. 3a and [FIG. 3b] show one embodiment of the system 1. This embodiment differs from that illustrated in [FIG. 1a] and [FIG. 1b] in that the window 22 has a thickness W₂₂, measured along the direction Z, of less than 50 μm, herein 10 μm. For this, a trench 220 is provided in the substrate 2, starting from the upper surface 2a of the substrate 2, so as to refine the thickness W₂₂ of the window 22. Thus transmission of radiation from the device 3 is increased.

Applicable to the embodiments of [FIG. 1a], [FIG. 1b], [FIG. 3a] and [FIG. 3b], the device 3 may be bonded to the window in order to improve coupling and avoid the use of an anti-reflective layer. Bonding is, for example, carried out at the molecular level (more commonly referred to as “molecular bonding” or “intimate bonding”). It can also be carried out using a polymerisable adhesive, for example an epoxy-based adhesive. The adhesive is, in an embodiment, polymerisable under the action of UV radiation, so that it remains passive to infrared radiation.

In the embodiment of [FIG. 3a] and [FIG. 3b], the system 1 also comprises a heat regulator 6 configured to regulate temperature of the device 3. The heat regulator 6 is, for example, a Peltier cell. A cold source of the heat regulator 6 is the surface emitting device 3 and a hot source of the heat regulator 6 is a thermal bath (such as a finned heat sink in contact with the ambient environment). In this embodiment, the heat regulator 6 is disposed under the substrate 2 and in direct contact with the lower face 2b thereof. More particularly, the regulator 6 is disposed in vertical alignment with the surface the device 3 to be regulated. The substrate 2 then serves as a thermal bridge between the device 3 and the heat regulator 6. Herein, in this embodiment, it is the portions of the substrate 2 adjoining the cavity 21a that act as a thermal bridge between the device 3 and the regulator 6. Indeed, the substrate 2, which may be made of Si, has a thermal conductivity of between 60 W/m/K and 150 W/m/K, thereby efficiently transferring heat from the device 3 to the heat regulator 6.

The surface emitting device 3 is beneficially configured so that the electromagnetic radiation (also referred to as a “beam” or “pencil”) is emitted along a direction substantially normal to the emitting face 3b. In other words, the radiation has, for example, an angle, measured in relation to the normal of said emitting face 3b, which is between 0° and 60°. This angle may also be between 0° and 20°. Thus, part of the resonator 21 substantially in vertical alignment with the surface the emitting face 3b can be illuminated by the beam. The angle of emission can be controlled by slightly modifying pitch of the diffraction grating 32.

FIG. 4 shows one embodiment of system 1 that differs from the embodiment in [FIG. 3a] and [FIG. 3b] in that device 3 includes an additional semiconductor layer 33 referred to as an “optical shoe”. The optical shoe 33 extends between the window 22 and the emitting face 3b of the device 3, in other words, between the window 22 and the second face 31b of the waveguide 31 of said device 3. In this embodiment, the shoe 33 rests at the bottom of the trench 220. This compensates for the extra thickness created by the shoe 33. The optical shoe 33 can be used to adapt the optical index of the waveguide 31 to that of the window 22.

In order to improve regulation, the heat regulator 6 can be disposed on the upper face 2a of the substrate 2, for example in proximity to the device 3, or even in direct contact with the device 3.

Beneficially, the heat regulator 6 is configured to regulate temperature of the surface emitting device 3. For example, the heat regulator 6 is configured to regulate temperature of said device 3 to within 0.1° C. when the latter is operating in steady state. The modulated operation of device 3 can be included in the steady state. Indeed, within the scope of a photoacoustic measurement, a molecule or medium is stimulated at an acoustic frequency (for example between 20 Hz and 20 kHz). The operation of the device 3 is therefore modulated (for example periodically switched on/off) according to this acoustic frequency.

Alternatively, regardless of whether the device is in steady or transient state, the heat regulator 6 can be configured to regulate temperature of said device 3 so that the time variation of the temperature of said device is less than 0.1° C./s.

FIG. 5 shows, in a cross-section along a plane {X; Z}, one embodiment of system 1 wherein beam E (black arrows) is emitted with a tilt with respect to the normal to emitter surface 3b. The beam E is thus injected into the main cavity 21a of the resonator 21, which is not in vertical alignment with the surface the device 3. For example, the device 3 is beneficially configured to emit radiation E at an angle α, measured relative to the normal of said emitting face 3b, of between 30° and 60°. Thus, reflections of radiation E against the inner wall delimiting the cavity 21a can allow radiation E to propagate throughout the cavity 21a.

In order to reduce the absorption of the beam E in the substrate 2, the resonator 21 may have a metal surface 23 which is arranged in the optical path of the beam E in order to promote reflections of the beam E in the resonator 21. For example, the metal surface 23 is disposed on a portion of the inner wall delimiting the main cavity 21a and oriented towards the emitting face 3b of the device 3 (the convention of orientation of the inner wall being defined as oriented from the substrate 2 towards the cavity 21a). Beneficially, the metal surface 23 is disposed over the entire inner wall delimiting cavity 21a, with the exception of the portion in contact with window 22. In this way, the electromagnetic radiation can penetrate the resonator 21 without any problem and illuminate a large part of the volume of the cavity 21a by virtue of the multiple reflections.

FIG. 6 schematically represents one embodiment of the system 1 for photoacoustic measurement of a sample 3. The sample 5 is, for example, a vascularised skin sample. The system 1 is configured to illuminate a portion of the sample and induce excitation of a targeted species in the sample, such as glucose in the blood vessels running through the sample 5. The photoacoustic response of the glucose can induce a vibration of the surface of the sample 5 which, being coupled to a cavity 21a, can be sensed by means of sound sensors 4 (not represented).

Unlike the embodiments set out above, in this embodiment the substrate 2 comprises a hollow volume 21a which is a through volume. That is open to the lower face 2b of the substrate 2. This hollow volume 21a, once pressed against the sample 5, forms a closed cavity in which a sound wave can propagate.

The device 3 rests on the window 22. The thickness W₂₂ of the window 22 is reduced, for example to less than or equal to 50 μm, by virtue of the trench 220 provided in the substrate 2, starting from the upper surface 2a.

In this embodiment, the system 1 also comprises a heat regulator 6, configured to regulate temperature of the device 3 in operation and, in an embodiment, in steady state. The embodiment of [FIG. 6] shows that the heat regulator 6 comprises active cells 61, such as Peltier cells, and a heat sink 62, such as a finned heat sink. The cells 61 are, for example, in contact with the substrate 2, provided that the heat transfer offered by the latter is sufficient. If it is made of Si, for example, it offers a heat transfer coefficient of about 150 W/m/K, which may be sufficient when there are just a few millimetres between the cells 61 and the device 3. The heat sink 62 is in contact with the cells 61 so as to dissipate heat pumped from the substrate 2. Heat insulators 63 can be added between the substrate 2 and the sample 5 to prevent the sample 5 from heating the device 3 or vice versa.

In one alternative, the cells 61 can be disposed against the substrate 2, in place of the heat insulators 63. In this case, the sample 5 can act as a heat sink. The heat regulator 61 thereby comprises only the cells 61.

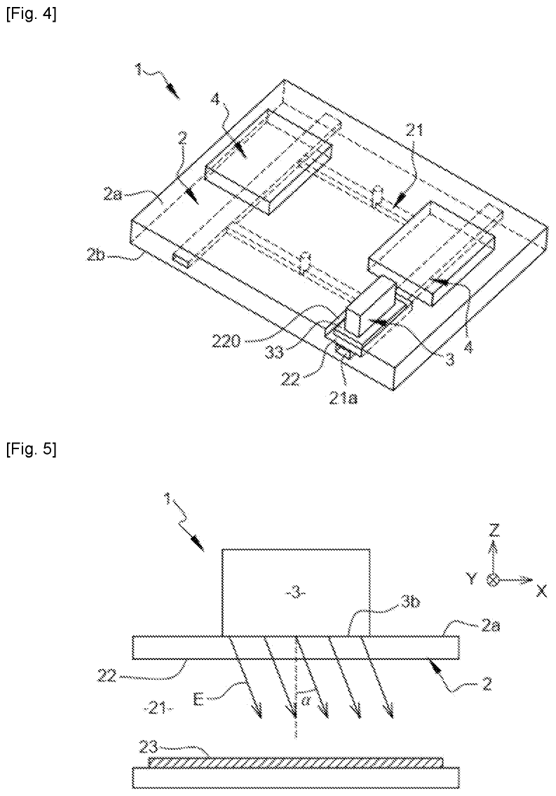

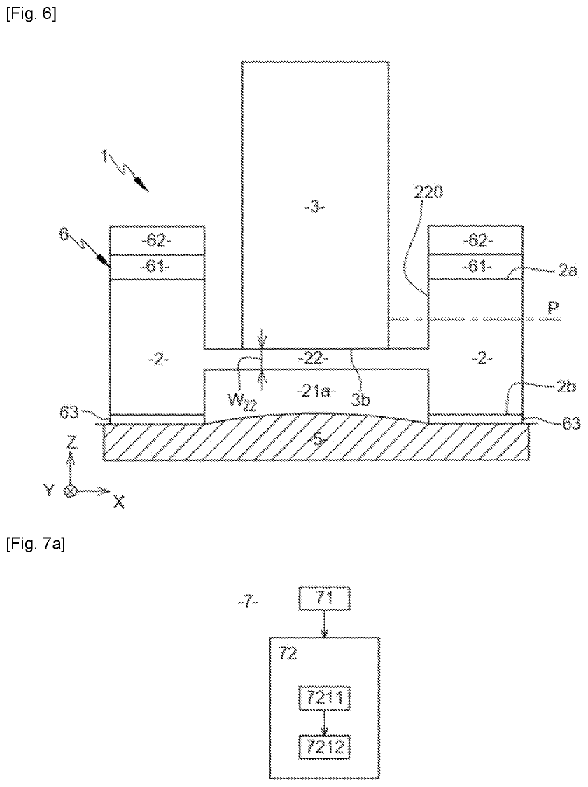

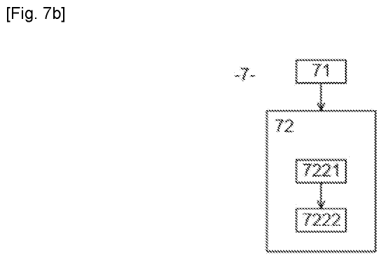

FIG. 7a and [FIG. 7b] schematically show two implementation modes of a method 7 for manufacturing a system 1 according to the invention.

Transversely to the two implementation modes illustrated, the method 7 comprises a step 71 of providing a substrate 2 comprising an upper face 2a and at least one window 22 associated with a hollow volume 21a (which may form part of a resonator 21 or may be a through volume). The hollow volume 21a (or the resonator 21) can be formed as described above, for example by etching an array of trenches on the surface of two thin substrates 2′, 2″ which, once bonded together, form the substrate 2 and enable the hollow volume 21a (or the resonator 21) to be formed. The wall is formed so that the hollow volume 21a extends into the substrate 2 below the upper face of the substrate 2 and at least one window 22 as previously defined extends in vertical alignment with at least one part of the hollow volume 21a.

The method 7 also includes a step 72 of manufacturing the surface emitting device 3 on the window 22. Manufacturing is performed so that the emitting face 3b of the device 3 rests on the window 22.

In the implementation mode of [FIG. 7a], manufacturing 72 the device 3 comprises a sub-step of forming 7211 the waveguide 31 on the window 22. For example, the waveguide 31 is formed on a different substrate and then bonded to the window 22. Alternatively, the layers making up the waveguide 31 may be deposited one after the other from the window 22. For example, forming 7211 the waveguide 31 may initially comprise a step of molecularly bonding a first semiconductor layer, for example made of InP, to the upper face 2a of the substrate 2, for example made of Si. A stack of semiconductor sub-layers can then be formed on said first semiconductor layer of InP to enable the active region 310 to be formed. A second semiconductor layer, for example of InP, is formed on the stack of semiconductor sublayers. Finally, etching the first and second InP semiconductor layers and the stack of semiconductor sublayers enables the waveguide 31 to be formed.

In this implementation mode, manufacturing 72 also includes a step of forming 7212 the diffraction grating 32 on the waveguide 31. The diffraction grating 32 can be formed 7212 on the waveguide 31 when the same is formed on a substrate different from the substrate 2. Thus, the assembly forming the device 3 is cut out and deposited (and bonded) on the window 22. Alternatively, when the layers making up the waveguide 31 are deposited onto the window 22, the grating 32 can be formed by depositing a metal layer on the second semiconductor layer of InP. A first etch of the metal layer forms the diffraction grating 32. A second, deeper etch delimits the perimeter of the diffraction grating 32 and the waveguide 31, thus forming the device 3.

In the implementation mode of [FIG. 7b], manufacturing 72 the device 3 first comprises a step of forming 7221 the diffraction grating 32. The diffraction grating 32 is, for example, formed on a different substrate and then offset to the window 22. Beneficially, the diffraction grating 32 is formed directly on the window 22. For example, a metal layer is deposited onto the window 22 and etched so as to form the grating 32. Alternatively, a grating of parallel trenches can be etched into the window 22 and filled with a metal or semiconductor material (but, in the latter case, different from the semiconductor material of the window 22).

In this implementation mode, manufacturing 72 the device 3 then comprises forming 7222 the waveguide 31 on the diffraction grating 32. For example, the waveguide 31 is formed on a different substrate and then offset to the window 22 and the grating 32. Alternatively, the layers making up the waveguide 31 can be directly deposited onto the grating 32. For example, forming 7222 the waveguide 31 comprises a step of molecularly bonding a first semiconductor layer, for example of InP, to the upper face 2a of the substrate 2 and therefore to the diffraction grating 32. A stack of semiconductor sub-layers is then formed on said first semiconductor layer of InP to form the active region 310. A second semiconductor layer, for example of InP, is formed on the stack of semiconductor sublayers. Finally, etching the first and second semiconductor layers of InP and the stack of semiconductor sublayers enables the waveguide 31 to be delimited in vertical alignment with the grating 32.

When the implementation modes of [FIG. 7a] and [FIG. 7b] provide for the offset of the waveguide 3 to the window 22 or to the grating 32, the waveguide 3 can be bonded. Either by molecular bonding or by means of a polymerisable adhesive. In the latter case, a portion of adhesive is deposited onto the window 22 (or the diffraction grating 32) and the device 3 is then deposited and pressed against this portion of adhesive.

The articles “a” and “an” may be employed in connection with various elements and components of compositions, processes or structures described herein. This is merely for convenience and to give a general sense of the compositions, processes or structures. Such a description includes “one or at least one” of the elements or components. Moreover, as used herein, the singular articles also include a description of a plurality of elements or components, unless it is apparent from a specific context that the plural is excluded.

It will be appreciated that the various embodiments and aspects of the inventions described previously are combinable according to any technically permissible combinations.

1. A photoacoustic system comprising:
a semiconductor substrate, the semiconductor substrate including a face forming an upper face, and an inner wall delimiting a hollow volume, the hollow volume extending into the semiconductor substrate at a distance from the upper face of said semiconductor substrate, the semiconductor substrate comprising at least one portion forming a window, transparent to an electromagnetic field, extending in vertical alignment with at least one part of the hollow volume and from the upper face of the semiconductor substrate up to the hollow volume, and
at least one surface emitting device comprising an emitting face, said emitting face extending over said window, said at least one surface emitting device comprising:
a waveguide comprising a first face and a second face, opposite to the first face, the waveguide comprising an active region configured to emit the electromagnetic field, and
a diffraction grating having, along a first direction parallel to the emitting face of said device, a diffraction order greater than or equal to two,
said diffraction grating extending over the first face of the waveguide, the emitting face being coincident with the second face of the waveguide; or said diffraction grating extending over the second face of the waveguide, the emitting face being coincident with the diffraction grating.

2. The system according to claim 1, wherein the diffraction grating of said at least one surface emitting device extends over the first face of the waveguide of said at least one surface emitting device and said diffraction grating is reflective.

3. The system according to claim 2, wherein the diffraction grating of said at least one surface emitting device comprises a periodic structure and a metal layer, the periodic structure extending over the first face of the waveguide and the metal layer extending over the periodic structure.

4. The system according to claim 1, wherein the diffraction grating of said at least one surface emitting device extends over the second face of the waveguide of said at least one surface emitting device and said diffraction grating is non-reflective.

5. The system according to claim 1, wherein the diffraction grating of said at least one surface emitting device extends in vertical alignment with the active region of the waveguide of said at least one surface emitting device, the active region having a length, measured along the first direction, and the diffraction grating of said at least one surface emitting device having a length, also measured along the first direction, the length of said diffraction grating being substantially equal to the length of said active region, said grating having, along the first direction, a single diffraction order.

6. The system according to claim 5, wherein the diffraction grating of said at least one surface emitting device has, along the first direction, a diffraction order greater than or equal to three.

7. The system according to claim 1, wherein the active region of said at least one surface emitting device has a width, measured along a second direction, parallel to the emitting face of said at least one surface emitting device and perpendicular to the first direction, and the diffraction grating of said at least one surface emitting device has a width, measured along the second direction, the width of said diffraction grating being substantially equal to the width of said active region, said diffraction grating having, along the second direction, another diffraction order, unique and greater than or equal to two.

8. The system according to claim 1, wherein the waveguide of said at least one surface emitting device is delimited by a first flank and a second flank, the second flank being opposite to the first flank, the first and second flanks being substantially perpendicular to the second face, said device also comprising a first conductive layer and a second conductive layer, the first conductive layer extending over the first flank and the second conductive layer extending over the second flank.

9. The photoacoustic system according to claim 1, wherein said at least one surface emitting device is bonded to the window.

10. The photoacoustic system according to claim 9, wherein said at least one surface emitting device is bonded to the window by molecular bonding or by a polymerisable adhesive.

11. The photoacoustic system according to claim 1, wherein said at least one surface emitting device is configured to emit infrared electromagnetic radiation via its emitting face at an angle, measured with respect to the normal of said emitting face, of between 0° and 60°.

12. The photoacoustic system according to claim 1, wherein the semiconductor substrate comprises a plurality of windows and the photoacoustic system comprises a plurality of surface emitting devices, each surface emitting device of the plurality of surface emitting devices being disposed on one window of the plurality of windows.

13. The photoacoustic system according to claim 1, wherein the electromagnetic radiation comprises a wavelength in the range from 0.8 μm to 20 μm.

14. The photoacoustic system according to claim 1, wherein the photoacoustic system comprises a heat regulator configured to regulate temperature of said at least one surface emitting device.

15. A method for manufacturing a photoacoustic system comprising, from a semiconductor substrate comprising a face forming an upper face:
forming an inner wall delimiting a hollow volume, the hollow volume extending into the semiconductor substrate at a distance from the upper face of said semiconductor substrate so that the semiconductor substrate comprises at least one portion forming a window, transparent to an electromagnetic field, extending in vertical alignment with at least one part of the hollow volume and from the upper face of the semiconductor substrate to the hollow volume;
manufacturing at least one surface emitting device extending over the window, said at least one device comprising:
a waveguide comprising a first face and a second face, opposite to the first face, the second face resting on said at least one window, the waveguide comprising an active region parallel to the second face configured to emit the electromagnetic field, and
a diffraction grating having a diffraction order greater than or equal to two and extending over the first face of the waveguide or over the second face of the waveguide.

16. The manufacturing method according to claim 15, wherein manufacturing said at least one surface emitting device comprises:
forming the waveguide of said at least one device on said at least one window of the semiconductor substrate, and
forming the diffraction grating of said at least one device on the first face of said waveguide.

17. The manufacturing method according to claim 15, wherein manufacturing said at least one surface emitting device comprises:
forming the diffraction grating of said at least one device on said at least one window of the semiconductor substrate, and
forming the waveguide of said at least one device on said diffraction grating.
